(19) United States
(12) Patent Application Publication
(10) Pub. No.: US 2009/0283573 A1
(43) Pub. Date: Nov. 19, 2009

(54) ELECTRODE WIRE MATERIAL AND SOLAR CELL HAVING CONNECTION LEAD WIRE FORMED OF THE WIRE MATERIAL

(75) Inventors: Kazuhiro SHIOMI, Mishima-gun (JP); Toshiaki FUJITA, Hirakata-shi (JP); Masaaki ISHIO, Osaka (JP)

Correspondence Address: Neomax Materials Co., Ltd.;c/o Keating & Bennett, LLP, 1800 Alexander Bell Drive, Suite 200, Reston, VA, 20191, US

(73) Assignee: NEOMAX MATERIALS CO., LTD., Osaka (JP)

(21) Appl. No.: 12/508,688

(22) Filed: Jul. 24, 2009

Related U.S. Application Data
(63) Continuation of application No. 10/558,214, filed on Jul. 26, 2006.

(30) Foreign Application Priority Data
May 22, 2003 (JP) 2003-144205

(51) Int. Cl. B23K 31/02

(52) U.S. Cl. 228/170

(57) ABSTRACT

An electrode wire material that can be used in a solar cell is produced without using flattening rolls or endless belts and has excellent solderability. The electrode wire material includes a core material formed of a strip-like conductive material and a hot-dip solder plated layer formed on a surface of the core material. A recessed portion for storing molten solder is formed in the core material along the longitudinal direction and the hot-dip solder plated layer is filled in the recessed portion. The recessed portion for storing molten solder preferably has an opening width in the lateral direction of the core material of about 90% or more of the width of the core material. The core material is preferably formed of a clad material including an interlayer of a low thermal expansion Fe alloy and copper layers formed on both surfaces of the interlayer.

### BACKGROUND OF THE INVENTION

1. Field of the Invention

The present invention relates to an electrode wire material to be used as a connection lead wire of electronic components such as solar cells.

2. Description of the Related Art

Solar cells respectively comprise a semiconductor substrate made of a silicon semiconductor having a PN junction and connection lead wires soldered to a plurality of front surface electrodes arranged linearly on the surface of the semiconductor substrate and in general, a plurality of such solar cells are connected in series so as to obtain a desired electromotive force. The series connection is achieved by connecting connection lead wires soldered to a front electrode of one solar cell to a rear electrode of another solar cell.

The electrode wire material before the connection lead wires being soldered to the front electrode of the semiconductor substrate includes a core material 51 of a pressed copper wire pressed to be flat by rolling a copper wire having a circular cross section and hot-dip solder plated layers 52, 52 formed on the both surfaces of the core material. As shown in FIG. 5, the hot-dip solder plated layers 52, 52 are formed on both surfaces of the core material 51 by a hot dip plating method, that is, the layers formed by passing the core material 51 whose surface is cleaned by acid pickling or the like through a molten solder bath. The hot-dip solder plated layer 52 has a hill-like shape expanded toward the center portion from the end portions as shown in FIG. 5 by surface tension at the time of solidification of the molten solder deposited on the core material 51.

At the time of soldering the electrode wire material to the semiconductor substrate, the heating temperature is strictly controlled to be a temperature around the melting point of the solder material. The reason for that is because the thermal expansion coefficient of copper forming the core material 51 of the electrode wire material and that of, for example, silicon forming the semiconductor substrate are quite different from each other. That is, soldering is carried out at a low temperature so as to suppress as much as possible the heat stress, which causes cracking in a costly semiconductor substrate. The heating at the time of soldering is generally carried out by heating with a hot plate on which the semiconductor substrate is mounted and heating the electrode wire material mounted on the semiconductor substrate from the upper side in combination.

However, as shown in FIG. 5, since the hot-dip solder plated layer of the electrode wire material has the hill-like shape expanded in the center portion, at the time of soldering the electrode wire material to the front electrodes of the semiconductor substrate, the contact region of the solder belt formed previously on the surface of the semiconductor substrate for easy electric communication to the front electrodes and the hot-dip solder plated layer becomes narrow and the heat transmission from the semiconductor substrate side to the hot-dip solder plated layer easily tends to be insufficient. In addition to that, the soldering temperature decreases. Hence, soldering failure tends to occur. In an extreme case, there occurs a problem that the connection lead wires come out of the semiconductor substrate during handling of the solar cell.

Therefore, various means have been tried in hot dip plating steps so as to make the hot-dip solder plated layer of the electrode wire material even in thickness as much as possible. For example, JP 7-243014-A (Patent Document 1) describes a technique of solidifying the plated layer under the condition that the strip-like material led out of a hot dip plating bath is rolled on a roll while the plated layer deposited on the surface of the material is still in a molten state or solidifying the plated layer while the strip-like material adhering the plated layer is sandwiched between a pair of endless belts. On the other hand, for example, JP 60-15937-A (Patent Document 2) proposes, as a conductive material with a small difference of the thermal expansion coefficient from that of the semiconductor material, a clad material composed of a plate of Invar (typical composition: Fe-36% Ni) of an Fe—Ni alloy, and copper plates unitedly formed on the both surfaces of the Invar plate.

As described above, to improve the solderability of an electrode wire material to be soldered to a semiconductor substrate, the hot-dip solder plated layer formed on the electrode wire material is better to be made as flat as possible. However, as described in Patent Document 1, to solidify the plated layer in A flat state, it is required to prepare flattening rolls and endless belts, strictly control the tension of the core material (a strip-like material) which is an object material to be plated, and carry out complicated operations for changing the roll diameter and the belt length corresponding to the plating temperature and plating speed.

### SUMMARY OF THE INVENTION

In order to overcome the problems described above, preferred embodiments of the present invention provide an electrode wire material which can be produced without using flattening solidifying devices such as flattening rolls and endless belts and has excellent solderability, and a solar cell of which the connection lead wire is formed of the electrode wire material.

An electrode wire material according to a preferred embodiment of the present invention includes a core material formed of a strip-like conductive material and a hot-dip solder plated layer formed on a surface of the core material. The core material has a recessed portion formed therein along the longitudinal direction for storing molten solder and the hot-dip solder plated layer is filled in the recessed portion. According to the electrode wire material, since the recessed portion for storage of molten solder are formed in the core material of the electrode wire material, when the molten solder is supplied to the recessed portion is solidified, even if the surface tension works on the molten solder, the center portion of the molten solder is hardly swollen and thus, the hot-dip solder plated layer tends to be flat. Hence, when the electrode wire material is mounted on the surface of the soldered element such as a solder belt of the semiconductor substrate such that the hot-dip solder plated layer makes contact with the soldered element, the contact region of the soldered element and the hot-dip solder plated layer is widened as compared with that of a conventional hill-like hot-dip solder plated layer, and thus, the thermal conductivity is improved. Therefore, the solderability of the electrode wire material is improved and excellent bondability can be obtained.

With respect to the electrode wire material, when the molten solder supplied to the recessed element for storing molten solder solidifies, to make the molten solder easily flat in the entire width of the core material, it is desirable to form the recessed element for storing molten solder such that the opening width of the recessed portion in the lateral direction of the core material is about 90% or higher in the width of the core material. Further, in order to make the opening width of the recessed portion for storing molten solder wide, it is desirable to form a recessed portion for storing molten solder in a recessed side of the core material which is formed to be dish-like or to have a curved cross-sectional shape in the perpendicular direction in relation to the longitudinal direction. Since such a shape is simple and easy to form, it is excellent in industrial productivity.

The core material is desirably formed of a clad material including copper layers formed on both surfaces of an interlayer composed of a low thermal expansion Fe alloy selected from an Fe—Ni alloy such as Invar or an Fe—Ni—Co alloy such as Kovar (trade name). Use of such a clad material for the core material makes it possible to remarkably decrease the thermal expansion coefficient as compared with that of a copper material, and then the thermal stress generated in the semiconductor substrate, which is soldered with the electrode wire material, can be decreased, and hence, a semiconductor substrate with further thinner thickness is made usable to lead to reduction in weight of the semiconductor substrate and cost reduction of the material.

The hot-dip solder plated layer can be formed of a lead-free solder material having a melting point of approximately 130° C. or higher and approximately 300° C. or lower. Such a solder scarcely causes environmental pollution with lead and its melting point is low, so that the solder is advantageous in that thermal stress is hardly generated when the electrode wire material is soldered to the semiconductor substrate.

Further, a solar cell according to another preferred embodiment of the present invention includes a semiconductor substrate formed of a semiconductor having a PN junction and a connection lead wire soldered to a plurality of front surface electrodes disposed on the surface of the semiconductor substrate. The connection lead wire is composed of the electrode wire material soldered to a plurality of front surface electrodes formed on the semiconductor substrate with the hot-dip solder plated layer. According to the solar cell, since the connection lead wire is composed of the electrode wire material soldered to the front surface electrodes on the semiconductor substrate with the flattened hot-dip solder plated layer filled in the recessed portion for storing molten solder, the connection lead wire is firmly bonded to the semiconductor substrate and hardly comes out of the semiconductor substrate, and thus, the solar cell has excellent durability.

According to the electrode wire material of various preferred embodiments of the present invention, since the hot-dip solder plated layer filled in the recessed portion for storing molten solder in the core material is easy to be flattened in the surface as compared with conventional one, it is possible to improve the solderability to the soldered element disposed on a semiconductor substrate or the like and then improve the bonding durability of the electrode wire material.

Further, according to the solar cell of another preferred embodiment of the present invention, since the connection lead wire is formed of the electrode wire material of which the hot-dip solder plated layer filled in the recessed portion for storing molten solder is soldered to a plurality of the front surface electrodes of the semiconductor substrate, the connection lead wire is firmly bonded to the semiconductor substrate and hardly comes out of the semiconductor substrate, and then the solar cell enhances the handling properties and durability.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a transverse cross-sectional view of an electrode wire material according to a preferred embodiment of the present invention.

FIG. 2 is a transverse cross-sectional view of an electrode wire material according to another preferred embodiment of the present invention.

FIG. 3 is a transverse cross-sectional view of an electrode wire material according to another preferred embodiment of the present invention.

FIG. 4 is a schematic perspective view of a solar cell according to another preferred embodiment of the present invention.

FIG. 5 is a transverse cross-sectional view of a conventional electrode wire material.

### DETAILED DESCRIPTION OF PREFERRED EMBODIMENTS

FIG. 1 shows an electrode wire material according to a first preferred embodiment of the present invention and the electrode wire material 1 preferably includes a strip-like core material 2 formed of a conductive material and hot-dip solder plated layers 5A, 5B formed on the both surfaces.

The core material 2 is preferably formed of a clad material including an interlayer 3 made of Invar and copper layers 4, 4 with the same cross sectional areas in both surfaces of the interlayer. Invar is an Fe—Ni alloy containing about 35 to about 38 mass % of Ni and is excellent in processibility and has a thermal expansion coefficient of about 1.2×10⁻⁶/° C. (in the case Ni=36.5 mass %), which is greatly lower than 16.5×10⁻⁶/° C. of copper. The ratio of the interlayer 3 and the copper layers 4 composing the core material 2 may be determined so as to adjust the thermal expansion coefficient in the plate surface direction to be approximately the same as that of a material of the semiconductor substrate, an object to be soldered thereto, for example, silicon (thermal expansion coefficient: 3.5×10⁻⁶/° C.) and in general, the area ratio of the interlayer 3 in the cross section (transverse cross section) in the perpendicular direction to the longitudinal direction of the electrode wire material 1 may be adjusted to be about 20% to about 60%. The width and thickness of the core material 2 may properly be determined depending on uses of the electrode wire material and in the case of use as a connection lead wire of a solar cell, the size of the core material is about 1 mm to about 3 mm in width and about 0.1 mm to about 0.3 mm in thickness.

The core material 2 is preferably formed so as to have a transverse cross sectional shape like a dish (dish-like cross sectional shape) recessed flatly in the center portion of one of its surfaces (the lower surface in the exemplified illustration). A recessed portion 6 for storing molten solder is formed in the recessed side. The hot-dip solder plated layer 5A solidified from the molten solder is filled in the recessed portion 6 and its surface is approximately flat. The depth of the recessed portion is preferably about 10 μm to about 30 μm in the deepest portion and the width (the opening width in the down surface) is preferably about 90% or higher of the width of the core material 2. The upper limit of the width is not particularly limited and the opening may be formed in the entire width of the lower surface.

The recessed portion 6 for storing molten solder can easily be formed by carrying out proper plastic forming or bending forming or the like for the strip-like material (a core raw material) of the clad material. For example, the strip-like material is passed through forming rolls having dish-like cross sectional shape between rolls to easily form the recessed portion. Also, in the case, the strip-like material is obtained by slitting a plate-like clad material, the gap or the rotational speed of rotary blades of a slitter may be adjusted properly so as to carry out bending forming in the side end portions of the slit strip-like material.

The core material 2 that is formed so as to be like a dish is washed to have a clean surface by acid pickling or with an organic solvent and then the core material 2 is passed through a molten solder bath to provide molten solder in the recessed portion 6 of the core material 2.

The surface of the molten solder supplied to and filled in the recessed portion 6 of the core material 2 is easily made flat since the molten solder filled in the recessed portion 6 is prevented from expanding at its center portion because of the surface tension as compared with that in the case of forming no recessed portion 6 (reference to FIG. 5). Hence, according to supplying the molten solder so as to be almost fully filled in the recessed portion 6, the surface of the molten solder stored in the recessed portion 6 in the entire width of the core material 2, specifically the surface of the hot-dip solder plated layer 5A after the solidification can be made flat.

To supply the recessed portion 6 with the molten solder so as to be almost fully filled, the molten solder bath temperature and the plating speed are properly controlled at the time of molten solder plating or after the core material 2 is dipped in a molten solder bath and pulled out, the excess molten solder rising up in the opening of the recessed portion 6 is removed by blowing hot air or is scraped out by a proper scraping member.

Examples of alloys that may be used as the solder material for forming the hot-dip solder plated layers 5A, 5B are Sn—Pb alloy, Sn-0.5 to 5 mass % Ag alloy, Sn-0.5 to 5 mass % Ag-0.3 to 1.0 mass % Cu alloy, Sn-0.3 to 1.0 mass % Cu alloy, Sn-1.0 to 5.0 mass % Ag-5 to 8 mass % In alloy, Sn-1.0 to 5.0 mass % Ag-40 to 50 mass % Bi alloy, Sn-40 to 50 mass % Bi alloy, and Sn-1.0 to 5.0 mass % Ag-40 to 50 mass % Bi-5 to 8 mass % In alloy, respectively, having a melting point of about 130° C. to about 300° C. Since Pb is harmful for human beings and possibly pollutes the natural environments, in terms of pollution prevention, Sn—Ag alloy, Sn—Ag—Cu alloy, Sn—Cu alloy, Sn—Ag—In alloy, and Sn—Ag—Bi alloy free of Pb respectively are preferable for the solder material. Also, these respective solder materials may include one or more elements selected from about 50 ppm to about 200 ppm of P, several to several tens ppm of Ga, several to several tens ppm of Gd, and several to several tens ppm of Ge. The hot-dip solder plated layers 5A, 5B may be made to have multilayer structure by using a variety of pure metals such as Sn, Ag and Cu, or their alloys. In such a case, the thickness of the respective layers is adjusted so as to be a prescribed alloy after melting. Such a multilayer structure is advantageous in that the components of the desired solder material can easily be adjusted by simply adjusting the thickness of the respective layers. The multilayer structure can be formed easily by successively carrying out metal plating.

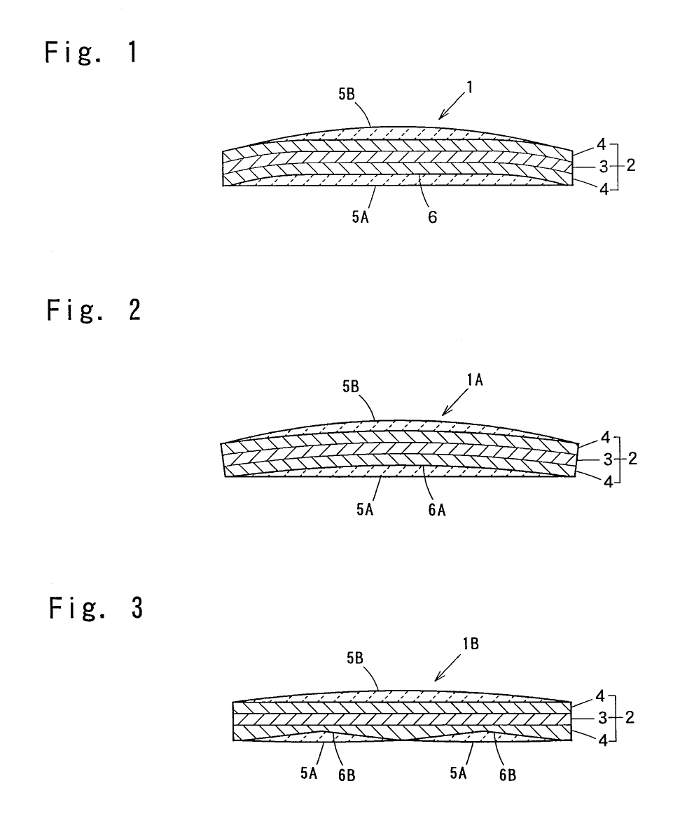

In the above-mentioned preferred embodiment, the core material 2 preferably has a dish-like shape as the transverse cross sectional shape of which the center bottom portion of the recessed portion 6 is flat, but the cross sectional shape of the core material is not particularly limited to such a shape and just like the electrode wire material 1A shown in FIG. 2, the cross section shape of the core material 2 may be curved as a whole. In such a case, the recessed portion 6A for storing molten solder has a bottom surface with the curved cross-section. Also, just like the electrode wire material 1B shown in FIG. 3, the cross section shape may have two partially recessed portions 6B, 6B having substantially triangular cross sectional shapes in the copper layer 4 in the lower surface side of the core material 2. In this case, the recessed portion for storing molten solder includes the partially recessed portions 6B, 6B. The partially recessed portions 6B, 6B can be formed easily by passing a strip-like plate of a clad material through forming rolls of which one has triangularly projected portions in the roll surface and pressurizing the strip-like plate by the forming rolls. Of course, the cross-sectional shapes of the partially recessed portions and the number of these portions are not limited as illustrated and proper shapes and number may be selected. In the preferred embodiments shown in FIG. 2 and FIG. 3, the same reference numerals are assigned to the same constituents of the electrode wire material 1 of the preferred embodiment of FIG. 1.

In the electrode wire materials 1, 1A, and 1B according to the above-mentioned preferred embodiments, a clad material including an interlayer 3 preferably composed of a Fe-35 to 38 mass % Ni alloy and copper layers 4, 4 formed on both surfaces of the interlayer 3 is preferably used for the core material 2. The interlayer may be composed of a Fe-29 to 37 mass % Ni-6 to 18 mass % Co alloy with a low expansion coefficient such as Kovar (trade name) or pure Fe. The core material may entirely be composed of a copper material, but when the core material is formed of the clad material (particularly, of which the interlayer is composed of a low thermal expansion Fe alloy such as Fe—Ni alloy or a Fe—Ni—Co alloy), the thermal expansion coefficient of the material is made similar to that of a semiconductor such as silicon and then the thermal stress can be lessened further at the time of soldering the electrode wire material to the semiconductor substrate.

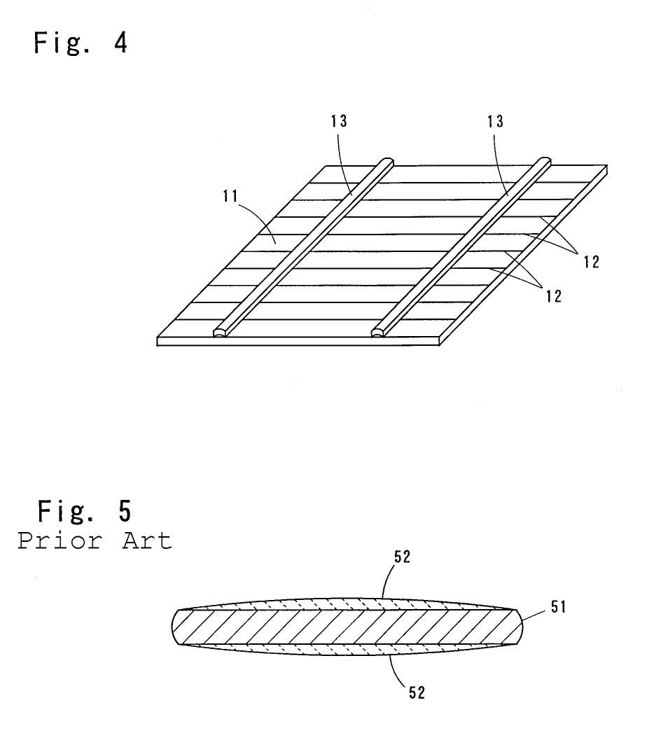

FIG. 4 shows a solar cell having connection lead wires that are formed of the electrode wire material 1 according to the first preferred embodiment of the present invention. The solar cell includes a semiconductor substrate 11 made of a silicon semiconductor having a PN junction and connection lead wires 13 soldered to a plurality of front surface electrodes 12 formed linearly on the surface of the semiconductor substrate 11. The semiconductor substrate 11 has rear surface electrodes formed on the rear surface of it.

On the semiconductor substrate 11 before the connection lead wires 13 are soldered, solder belts are arranged at right angles relative to a plurality of the front surface electrodes 12 so as to connect to the front surface electrodes 12. Along the solder belt, the electrode wire material 1 is mounted on the semiconductor substrate 11 so as to cause the hot-dip solder plated layer 5A of the electrode wire material 1 to contact with the solder belt. And the solder belt on the semiconductor substrate 11 and the hot-dip solder plated layer 5A of the electrode wire material 1 are melted together to solder the electrode wire material 1 on the surface of the semiconductor substrate 11. Accordingly, the connection lead wires 13 formed of the electrode wire material 1 can be bonded to the semiconductor substrate 11.

According to the solar cell, since the hot-dip solder plated layer 5A of the electrode wire material 1 is filled in the recessed portion 6 and results in the flat surface having excellent solderability, the connection lead wires 13 are firmly bonded to the semiconductor substrate 11. Hence, the connection lead wires hardly come out of the semiconductor substrate and are excellent in durability. As the connection lead wires 13 in the solar cell, not only the electrode wire material 1 of the first preferred embodiment but also electrode wire materials 1A, 1B according to other preferred embodiments can be used and similar effects can be brought by using any of these electrode wire materials.

Hereinafter, the electrode wire material of various preferred embodiments of the present invention will be described more specifically by way of examples thereof, however it should be understood that the present invention is not limited by or to the examples.

### EXAMPLES

A clad material (0.18 mm thick) including a middle layer with a thickness of about 60 μm composed of Invar (Fe-36.5 mass % Ni) and copper layers each having a thickness of about 60 μm formed on both surfaces of the interlayer was prepared. Strip-like materials each having a width of about 2 mm were produced from the clad material by a slitter and the strip-like materials were further cut into pieces each having a length of about 40 mm to obtain core materials related to examples. When slitting by the slitter, the intervals of rotary blades were adjusted so as to carry out bending forming in the end portions in the width direction of the each strip-like material to make the transverse cross sectional shape of the core material dish-like as shown in FIG. 1. The cross-sectional shape was observed by an optical microscope (magnification about 200 times) to find that the deepest depth in the recessed portion formed in the recessed side of the core material was about 20 μm and the opening width of the recessed portion was about 95% of the core material width. On the other hand, core materials with each length of about 40 mm related to comparative examples were produced from a pressed flat wire with a thickness of about 0.18 mm and a width of about 2 mm composed of copper.

After these core materials were cleaned in the surface with an organic solvent (acetone), each of the core materials was dipped in a molten solder bath (solder composition: Sn-3.5 mass % Ag; melting point: 220° C., and bath temperature: 300° C.) and quickly pulled out to form hot-dip solder plated layer on the surface of the core material. After this process, an electrode wire material was obtained. With respect to the electrode wire materials of the examples, each hot-dip solder plated layer was filled in the recessed portion and was almost flat in the surface along the entire width of the core material. On the other hand, each of the electrode wire materials of the comparative examples, as shown in FIG. 5, showed a hill-like shape expanded in the center portion from side end portions of the core material.

The electrode wire materials of the examples and comparative examples produced in such a manner were coated with a proper amount of a flux (NS-30, manufactured by Nihon Superior Co., Ltd.). Each electrode wire material was mounted on an oxygen-free copper strip plate (about 0.5 mm thick, about 4 mm wide, and about 40 mm long) such that the hot-dip solder plated layer contacts with the center portion in the width direction of the copper strip plate along the longitudinal direction. The copper strip plate and the electrode wire material thereon were put on the hot plate and heated (kept at about 260° C. for about 1 minute) to solder the electrode wire material to the copper strip plate.

After that, the electrode wire material and copper strip plate was pulled in the opposed directions with a tensile tester to peel the electrode wire material from the copper plate, and the tensile force required for peeling was measured. The test was repeated 5 times for each sample and the average value was calculated. As a result, the tensile force was about 14.1 N for the examples and 8.1 N for the comparative examples. Accordingly, the electrode wire materials of the examples had a joining force of about 1.7 times as compared to that of the electrode wire materials of the comparative example and thus, it was confirmed that the electrode wire materials of the examples had excellent solderability.

While the present invention has been described with respect to preferred embodiments thereof, it will be apparent to those skilled in the art that the disclosed invention may be modified in numerous ways and may assume many preferred embodiments other those specifically set out and described above. Accordingly, it is intended by the appended claims to cover all modifications of the present invention which fall within the true spirit and scope of the present invention.

1. A method of producing an electrode wire material comprising a core material having a recessed portion arranged to store molten solder along a longitudinal direction thereof and a hot-dip solder plated layer filled in the recessed portion, comprising the steps of:
slitting a conductive plate-like material into strip-like materials, with both side end portions of the each strip-like material bended with rotary blades of a slitter to form into the recess portion, whereby obtaining the core materials; and
subjecting each of the core materials to a hot-dip solder plating by passing through a molten solder bath to make the recess portion thereof filled with molten solder

2. The method of producing an electrode wire material according to claim 1, wherein the recessed portion has a width in a lateral direction of the core material of about 90% or more of the width of the core material.

3. The method of producing an electrode wire material according to claim 1, wherein the recessed portion has an opening between both ends in a lateral direction of the core material.

4. The method of producing an electrode wire material according to claim 1, wherein the recessed portion has a dish-like shape in cross section in a direction that is substantially perpendicular to the longitudinal direction.

5. The method of producing an electrode wire material according to claim 1, wherein the conductive plate-like material is made of a clad material including an interlayer of a low thermal expansion Fe alloy selected from a Fe—Ni alloy or Fe—Ni—Co alloy and copper layers disposed on both surfaces of the interlayer.

6. The method of producing an electrode wire material according to claim 1, wherein the solder is composed of a solder material having a melting point of about 130° C. or higher and about 300° C. or lower and free of lead.

7. The method of producing an electrode wire material according to claim 1, wherein the strip-like material has a width in a lateral direction of about 1 mm to 3 mm and a thickness of about 0.1 mm to 0.3 mm.
